(19) United States
(12) Patent Application Publication
(10) Pub. No.: US 2026/0070431 A1
(43) Pub. Date: Mar. 12, 2026

(54) SHIELDING STRUCTURE FOR VEHICLE BATTERY UNIT

(71) Applicants: HAYASHI TELEMPU CORPORATION, Nagoya-shi (JP); TOYOTA JIDOSHA KABUSHIKI KAISHA, Toyota-shi (JP)

(72) Inventors: Takeshi FUJIMOTO, Nagoya-shi (JP); Motohisa NARUSE, Nagoya-shi (JP); Tsuyoshi KITAHARA, Toyota-shi (JP)

(21) Appl. No.: 19/350,058

(22) Filed: Oct. 6, 2025

Related U.S. Application Data
(63) Continuation of application No. PCT/JP2024/004799, filed on Feb. 13, 2024.

(30) Foreign Application Priority Data
Apr. 13, 2023 (JP) 2023-065598

(51) Int. Cl. B60L 50/64; B60L 50/60

(52) U.S. Cl. CPC B60L 50/64; B60L 50/66

(57) ABSTRACT

A shielding structure for a battery unit located above a panel and under in-vehicle equipment in a vehicle includes: a fibrous first sound-absorbing member located on the panel and in contact with a lower part of the battery unit; and a fibrous second sound-absorbing member surrounding an upper part and side parts of the battery unit. The battery unit is surrounded by the first sound-absorbing member and the second sound-absorbing member.

### CROSS-REFERENCE TO RELATED APPLICATIONS

This Application claims the benefit of priority and is a Continuation application of the prior International Patent Application No. PCT/JP2024/004799, with an international filing date of Feb. 13, 2024, which designated the United States, and is related to the Japanese Patent Application No. 2023-065598, filed Apr. 13, 2023, the entire disclosures of all applications are expressly incorporated by reference in their entirety herein.

### FIELD OF THE INVENTION

The present invention relates to a shielding structure for a vehicle battery unit.

### DESCRIPTION OF RELATED ART

Electric vehicles, including hybrid vehicles, are equipped with a battery unit including a high-voltage battery as a power source for the electric motor, the battery unit being located, for example, under the rear seat. The high-voltage battery includes multiple rechargeable secondary battery cells (for example, lithium-ion cells) that can be charged by external power. The battery unit is equipped with components such as a blower and ducts to air-cool the high-voltage battery. Heat is generated from inside the battery unit, and noise is generated from the blower.

Japanese Unexamined Patent Application Publication No. 2021-146753 discloses a cover made of metal or synthetic resin that covers the battery unit from above.

### BRIEF SUMMARY OF THE INVENTION

The noise and the heat generated from the battery unit are released into the vehicle cabin. Thus, it is desirable to reduce the noise and other emissions released from the battery unit.

One aspect of the present invention provides a shielding structure for a battery unit located above a panel and under in-vehicle equipment in a vehicle, the shielding structure comprising:
a fibrous first sound-absorbing member located on the panel and in contact with a lower part of the battery unit; and
a fibrous second sound-absorbing member surrounding an upper part and side parts of the battery unit, wherein
the battery unit is surrounded by the first sound-absorbing member and the second sound-absorbing member.

According to the present invention, it is possible to provide a preferred structure for reducing the noise from the battery unit.

### BRIEF DESCRIPTION OF THE DRAWINGS

FIG. 1 is a schematic perspective view illustrating a main part of an automobile equipped with a shielding structure for a battery unit.

FIG. 2 is a schematic cross-sectional view illustrating a main part of the automobile equipped with the shielding structure for the battery unit, in a vertical cross-section along a front-rear direction.

FIG. 3 is a schematic cross-sectional view illustrating a main part of the automobile equipped with the shielding structure for the battery unit, in a vertical cross-section along a width direction.

FIG. 4 is a schematic cross-sectional view showing an example of a structure of a second sound-absorbing member.

FIG. 5 is a schematic perspective view illustrating a main part of the shielding structure with an outer surface of the second sound-absorbing member visible.

FIG. 6 is a schematic perspective view illustrating a main part of the automobile equipped with the shielding structure for the battery unit.

FIG. 7 is a schematic perspective view illustrating a main part of the shielding structure with a second opening of a sound-insulating cover in an open state.

FIG. 8 is a schematic perspective view illustrating a main part of the shielding structure with a first opening of the second sound-absorbing member in an open state.

### DETAILED DESCRIPTION OF THE INVENTION

Some embodiments of the present invention will be described below.

Of course, the following embodiments merely exemplify the present invention, and not all features shown in the embodiments are necessarily essential to the solution.

### (1) Overviews of the Present Disclosure

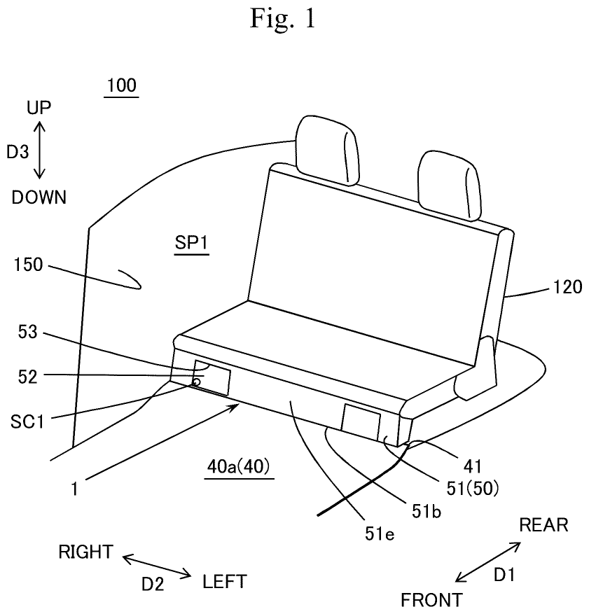

First, overviews of the present disclosure are given referring to examples shown in FIGS. 1 to 8. The figures in the present application are schematic illustrations of examples, magnification ratio in each direction shown in these figures may differ, and the figures may not be consistent with each other. Of course, each element of the present disclosure should not be limited to the specific examples indicated by reference signs.

In the present application, the numerical range “Min to Max” refers to the minimum value Min or more and the maximum value Max or less.

### Embodiment 1

As illustrated in FIGS. 1-3, a shielding structure 1 according to one embodiment of the present disclosure is a shielding structure 1 for a battery unit 130 located above a panel 110 and under in-vehicle equipment (for example, rear seat 120) in a vehicle (for example, automobile 100), comprising a first sound-absorbing member 10 and a second sound-absorbing member 20. The first sound-absorbing member 10 is fibrous, located on the panel 110, and in contact with a lower part 132 of the battery unit 130. The second sound-absorbing member 20 is fibrous, and surrounds an upper part 131 and side parts 133 of the battery unit 130. The battery unit 130 is surrounded by the first sound-absorbing member 10 and the second sound-absorbing member 20.

From the above, the fibrous sound-absorbing members surrounding the battery unit 130 absorb noise from the battery unit 130. The above embodiment makes it possible to provide the preferred structure for reducing the noise from the battery unit in the vehicle. Additionally, it is possible to reduce the heat emitted from the battery unit.

Herein, examples of the vehicle broadly include electric vehicles equipped with an electric motor as a motor. Examples of the electric vehicles include a hybrid vehicle equipped with both a drive motor and an engine, a fuel cell vehicle that uses a fuel cell as a power source for the electric motor, and the like.

Examples of the in-vehicle equipment include a seat such as a rear seat, a lid member covering the upper side of the battery unit, and the like.

The fibrous sound-absorbing member refers to a material that exhibits sound-absorbing performance through gaps between fibers, and may contain materials other than fibers as long as it contains fibers. Examples of the fibrous sound-absorbing member include a fibrous material such as felt containing fibers and binders, a laminated material in which a design layer is laminated on a base material containing a fibrous material, and the like.

The side parts of the battery unit include the left side part of the battery unit, the right side part of the battery unit, the front side part of the battery unit, and the rear side part of the battery unit.

The first sound-absorbing member and the second sound-absorbing member surrounding the battery unit may have structures necessary for the electric vehicles, such as recesses or holes for fixing the battery unit to the panel, recesses or holes for extending ducts of the battery unit to the outside, and so on.

In the present application, the terms “first”, “second”, . . . are used to identify each component in multiple components having similarities, and may not mean order.

The above additional remarks also apply to the following embodiments.

### Embodiment 2

As illustrated in FIGS. 1-3, the present shielding structure 1 may further comprise a floor interior member 40 located on the panel 110 at a position more forward than the first sound-absorbing member 10. The second sound-absorbing member 20 may have a front edge part 21 on which the floor interior member 40 is placed, and may have a second edge part 22 aligned with the upper surface 10a of the first sound-absorbing member 10.

In the above case, the noise and other emissions from the battery unit 130 toward the front are blocked by the floor interior member 40 placed on the front edge part 21 of the second sound-absorbing member 20. Furthermore, the noise and other emissions from the battery unit 130 toward the second edge part 22 of the second sound-absorbing member 20 are blocked by the second edge part 22.

The above embodiment makes it possible to provide an even more preferred structure for reducing the noise and other emissions from the battery unit.

### Embodiment 3

As illustrated in FIGS. 1-3 and 6, the present shielding structure 1 may further comprise a sound-insulating cover 50 outside the second sound-absorbing member 20 surrounding the side parts 133 of the battery unit 130. The sound-insulating cover 50 may keep pressing the edge parts (front edge part 21 and second edge part 22) of the second sound-absorbing member 20 from above. The present shielding structure 1 may have a clearance CL1 between the sound-insulating cover 50 and the second sound-absorbing member 20.

In the above case, a double wall having the clearance CL1 is formed by the second sound-absorbing member 20 and the sound-insulating cover 50. The above embodiment makes it possible to provide an even more preferred structure for reducing the noise and other emissions from the battery unit.

Herein, the sound-insulating cover 50 may keep pressing the edge parts (21 and 22) of the second sound-absorbing member 20 from above through another component such as the floor interior member 40 or the like.

Furthermore, the sound-insulating cover 50 may be divided into multiple parts. For example, the sound-insulating cover 50 may include a front sound-insulating cover 51 that keep pressing the front edge part 21 of the second sound-absorbing member 20 from above through the floor interior member 40, and a rear sound-insulating cover 56 that directly keep pressing the second edge part 22 of the second sound-absorbing member 20 from above.

The above additional remarks also apply to the following embodiments.

### Embodiment 4

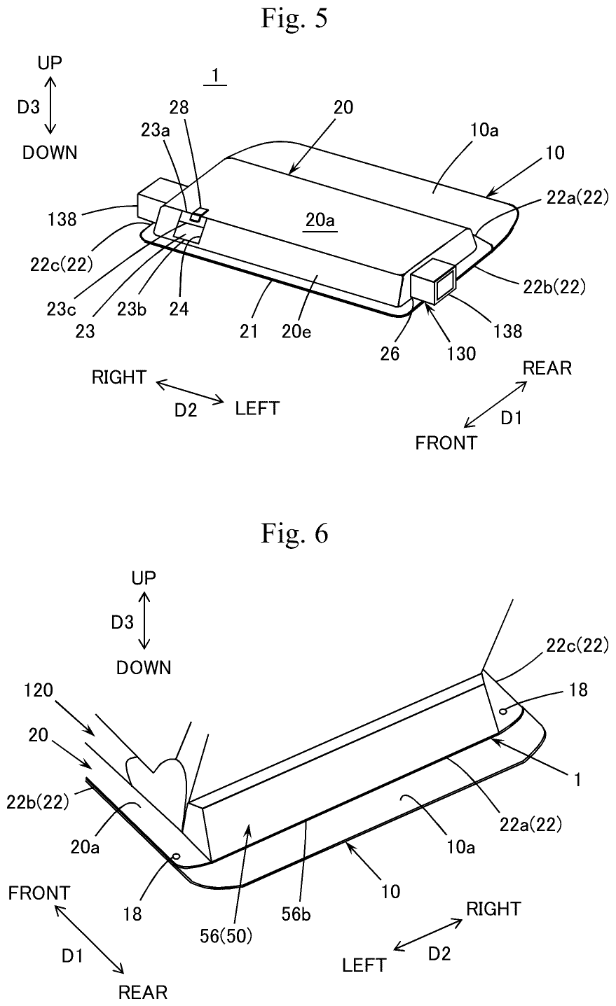

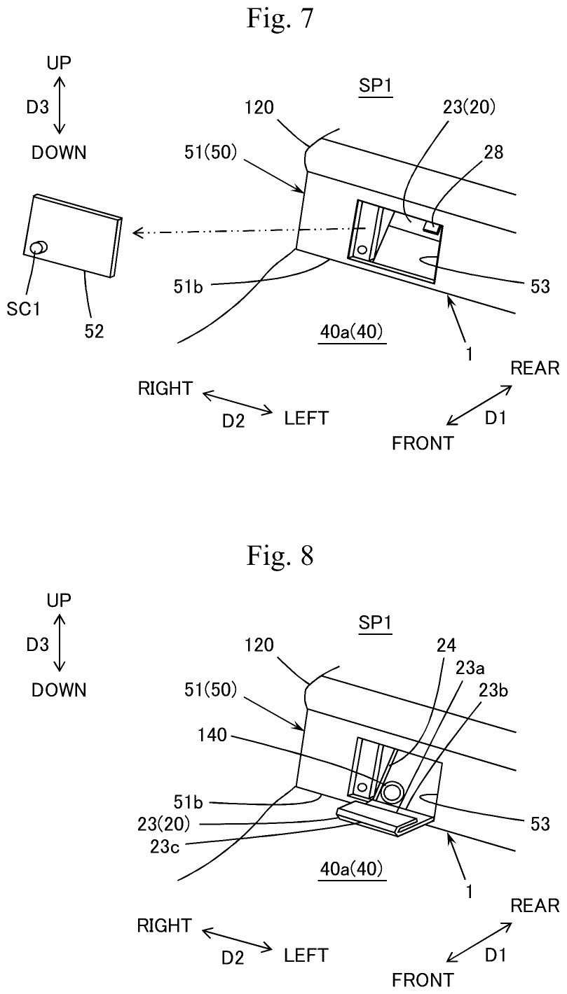

As illustrated in FIGS. 5 and 8, the second sound-absorbing member 20 may include a first lid 23 capable of opening and closing a first opening 24 for accessing a connector 140 of the battery unit 130. As illustrated in FIG. 7, the sound-insulating cover 50 may include a second lid (for example, lid 52) capable of opening and closing a second opening 53 for accessing the connector 140 through the first opening 24.

In the above case, an operator can access the connector 140 of the battery unit 130 through the second opening 53 of the sound-insulating cover 50 via the first opening 24 of the second sound-absorbing member 20 by performing the operation of opening the second lid (52) and then performing the operation of opening the first lid 23. The above embodiment makes it possible to perform maintenance of the battery unit and the like without removing the sound-insulating cover or the second sound-absorbing member.

### Embodiment 5

As illustrated in FIG. 4, the second sound-absorbing member 20 may include a fibrous base material layer 31 whose weight per unit area is 300 to 1000 g/m², the base material layer 31 being in contact with the upper part 131 of the battery unit 130. The second sound-absorbing member 20 may include a fibrous design layer 33 whose weight per unit area is 50 to 300 g/m², the design layer 33 being adhered to the base material layer 31.

In the above case, even if the surface of the second sound-absorbing member 20 is dented by an umbrella or similar object, the second sound-absorbing member 20 can return to its original shape, and even if the second sound-absorbing member 20 is visible through the clearance CL1 of the in-vehicle equipment (120), the second sound-absorbing member 20 has a good appearance. The above embodiment makes it possible to provide a preferred example of the shielding structure for the battery unit.

It should be noted that a case where the design layer 33 adheres to the base material layer 31 through an adhesive layer 32 is also included in the above Embodiment 5.

### (2) Specific Example of a Shielding Structure for a Battery Unit

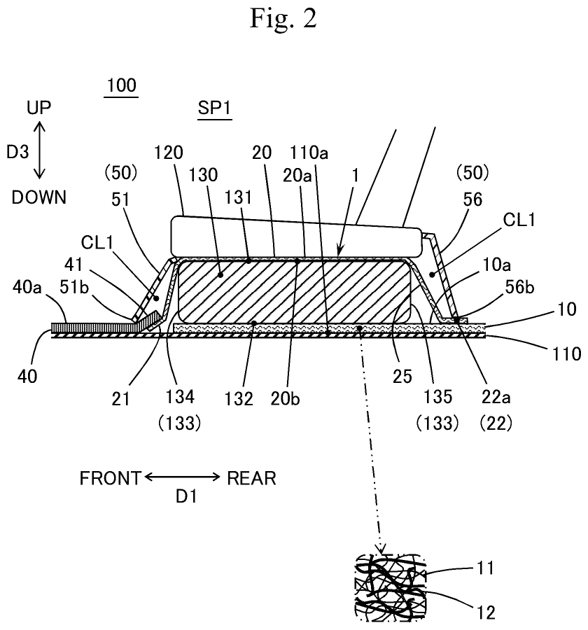

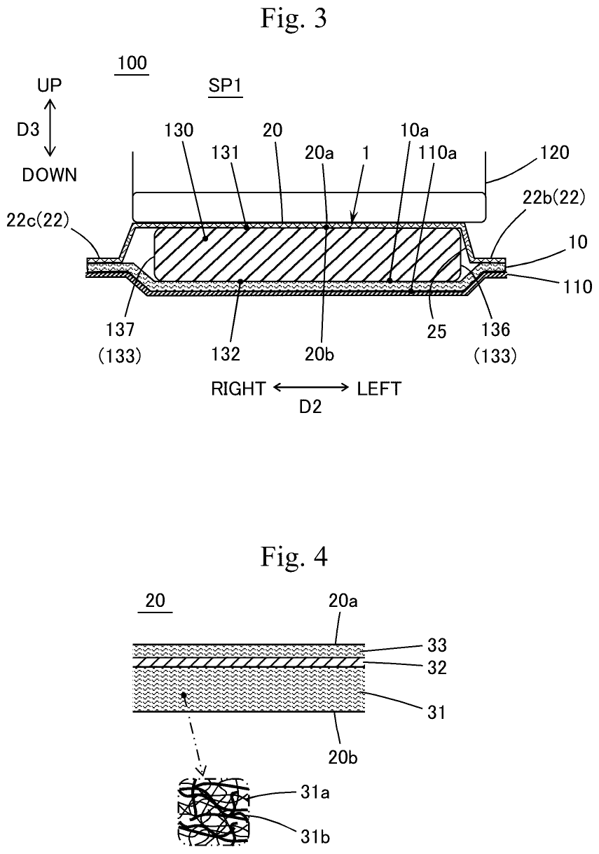

FIG. 1 schematically illustrates the main part of the automobile 100 equipped with the shielding structure 1 for the battery unit 130. FIG. 2 is a schematic cross-sectional view illustrating the main part of the automobile 100 in a vertical cross-section along a front-rear direction D1. The lower part of FIG. 2 shows a schematic enlarged cross-sectional view of the fibrous first sound-absorbing member 10. FIG. 3 schematically illustrates the main part of the automobile 100 in a vertical cross-section along a width direction D2. FIG. 4 is a schematic cross-sectional view illustrating the structure of the fibrous second sound-absorbing member 20. The lower part of FIG. 4 shows a schematic enlarged cross-sectional view of the base material layer 31 of the second sound-absorbing member 20. FIG. 5 schematically illustrates the main part of the shielding structure 1 with an outer surface 20a of the second sound-absorbing member 20 visible. FIG. 6 schematically illustrates the main part of the automobile 100 from the rear. In the figures of the present application, FRONT, REAR, LEFT, RIGHT, UP, and DOWN indicate front, rear, left, right, up, and down, respectively. The left-right positional relationship is based on the direction of looking forward in the automobile 100. In addition, the reference sign D1 indicates the front-rear direction of the automobile, the reference sign D2 indicates the width direction of the automobile, and the reference sign D3 indicates the up-down direction. For clarity, the magnification ratios in the front-rear direction D1, the width direction D2, and the up-down direction D3 may differ, the thickness of each part may be exaggerated, and the figures may not be consistent with each other.

The automobile 100 shown in FIGS. 1-3 is an electric vehicle equipped with the battery unit 130. The electric vehicle may be a hybrid vehicle equipped with both a drive motor and an engine, and is equipped with an electric motor as a prime mover. The battery unit 130 is equipped with a high-voltage battery, a blower for air cooling, ducts 138 shown in FIG. 5, a connector 140 (refer to FIG. 8) on the power supply path from the high-voltage battery, and so on. The high-voltage battery includes multiple rechargeable secondary battery cells (for example, lithium-ion cells) that can be charged by external power. The ducts 138 may be air intake ducts that draw in air or exhaust ducts that expel air. The blower cools the high-voltage battery with air from the air intake ducts. Consequently, noise is generated from the blower, and heat is generated from the battery unit 130.

The body of the automobile 100 is formed with panels 110 surrounding an interior space SP1 such as a cabin. The panels 110 have a three-dimensional shape with unevenness. The panels 110 include vehicle body panels made of metal panels such as steel plates, and may include resin panels or the like. On the upper surface 110a of the panel 110 shown in FIGS. 2 and 3, the first sound-absorbing member 10 is installed under the rear seat 120 (an example of in-vehicle equipment), and the floor interior member 40 is installed at a position more forward than the first sound-absorbing member 10. The battery unit 130 is placed on the upper surface 10a of the first sound-absorbing member 10. In other words, the first sound-absorbing member 10 is located on the panel 110 and is in contact with the lower part 132 of the battery unit 130. The rear seat 120 is placed above the battery unit 130 through the second sound-absorbing member 20 in the interior space SP1. In other words, the battery unit 130 is located above the panel 110 and under the rear seat 120. On both the left and right sides of the interior space SP1, deck side trims 150 attached to deck side panels as the body panels are placed.

The left and right ducts 138 shown in FIG. 5 are connected to the space between the deck side panels and the deck side trims 150. If the left and right ducts 138 are air intake ducts, the battery unit 130 draws air into its interior from the space between the deck side panels and the deck side trims 150 by driving the internal blower of the battery unit. If an exhaust duct (not shown) connected to the space between the deck side panel and the deck side trim 150 is located at the lower part 132 of the battery unit 130, the battery unit 130 expels warmed air from its interior into the space between the deck side panel and the deck side trim 150 through the exhaust duct by driving the internal blower of the battery unit. In addition, one of the left and right ducts 138 may be the air intake duct, and the other may be the exhaust duct.

The shielding structure 1 for reducing the noise and the heat from the battery unit 130 includes, as basic elements, the fibrous first sound-absorbing member 10 and the fibrous second sound-absorbing member 20. The first sound-absorbing member 10 is formed by press-molding fibrous material and has a three-dimensional shape with unevenness. The second sound-absorbing member 20 is also formed by press-molding fibrous material and has a three-dimensional shape with unevenness. The second sound-absorbing member 20 surrounds the upper part 131 and the side parts 133 of the battery unit 130. In other words, the second sound-absorbing member 20 has a concave portion 25 in which the battery unit 130 is placed, the concave portion 25 being on the lower surface 20b facing downward on the second sound-absorbing member 20. In the outer surface 20a of the second sound-absorbing member 20, the portion corresponding to the upper part 131 of the battery unit 130 faces upward, and the portion corresponding to the side parts 133 of the battery unit 130 faces diagonally upward. In the battery unit 130, the side parts 133 include, as shown in FIGS. 2 and 3, a front part 134, a rear part 135, a left part 136, and a right part 137. Thus, in the outer surface 20a of the second sound-absorbing member 20, the portion corresponding to the front part 134 faces forward, the portion corresponding to the rear part 135 faces rearward, the portion corresponding to the left part 136 faces leftward, and the portion corresponding to the right part 137 faces rightward. In the portions of the second sound-absorbing member 20 corresponding to the left part 136 and right part 137, recesses 26 are formed for extending the ducts 138 of the battery unit 130 to the outside. The rear edge part 22a, left edge part 22b, and right edge part 22c of the second sound-absorbing member 20 are placed on the upper surface 10a of the first sound-absorbing member 10. The rear edge part 22a, left edge part 22b, and right edge part 22c are examples of the second edge part 22 aligned with the upper surface 10a of the first sound-absorbing member 10. As shown in FIG. 6, both left and right sides of the rear edge part 22a of the second sound-absorbing member 20 are fixed to the first sound-absorbing member 10 with clips 18. The battery unit 130 is surrounded by the first sound-absorbing member 10 and the second sound-absorbing member 20.

As shown in FIG. 5, the second sound-absorbing member 20 has a first opening 24 at the position corresponding to the connector 140 shown in FIG. 8, and includes a first lid 23 capable of opening and closing the first opening 24. The first lid 23 has a bending part 23c between its upper edge 23a and lower edge 23b, and can be bent at the lower edge 23b and the bending part 23c. Herein, the portion of the second sound-absorbing member 20 excluding the first lid 23 is referred to as the body 20e. When the first lid 23 closes the first opening 24, the upper edge 23a of the first lid 23 is held to the body 20e of the second sound-absorbing member 20 by a hook-and-loop fastener 28.

The shielding structure 1 may include, as additional elements, the floor interior member 40 and the sound-insulating cover 50. The floor interior member 40 shown in FIG. 2 has a rear edge part 41 placed on the front edge part 21 of the second sound-absorbing member 20. This causes the front edge part 21 of the second sound-absorbing member 20 to be kept pressing from above by the weight of the floor interior member 40. The sound-insulating cover 50 includes the front sound-insulating cover 51 and the rear sound-insulating cover 56.

The first sound-absorbing member 10 on the panel 110 is, as shown in the lower part of FIG. 2, a fiber aggregate containing fibers 11 and a binder 12. The weight per unit area of the first sound-absorbing member 10 may be, for example, 300 to 2000 g/m², more preferably 800 to 1500 g/m². The thickness of the first sound-absorbing member 10 may be, for example, 5.0 to 20.0 mm, more preferably 7.0 to 15.0 mm.

The second sound-absorbing member 20 includes, as shown in FIG. 4, the fibrous base material layer 31 configured to be in contact with the upper part 131 of the battery unit 130, and the fibrous design layer 33 adhered to the base material layer 31. The design layer 33 may adheres to the base material layer 31 through the adhesive layer 32. The base material layer 31, which appears on the lower surface 20b of the second sound-absorbing member 20, is, as shown in the lower part of FIG. 4, a fiber aggregate containing fibers 31a and a binder 31b. The weight per unit area of the base material layer 31 may be, for example, 300 to 1000 g/m². Since the second sound-absorbing member 20 has the fibrous base material layer 31, even if the surface of the second sound-absorbing member 20 is dented by an umbrella or similar object, the second sound-absorbing member 20 can return to its original shape. For the design layer 33, which appears on the outer surface 20a of the second sound-absorbing member 20, a fibrous skin material such as nonwoven fabric can be used. The weight per unit area of the design layer 33 may be, for example, 50 to 300 g/m². Since the design layer 33 appears on the outer surface 20a of the second sound-absorbing member 20, even if the second sound-absorbing member 20 is visible under the rear seat 120, the second sound-absorbing member 20 has a good appearance. The adhesive layer 32 may be a fiber layer containing a binder, or may be a synthetic resin layer having numerous openings to provide air permeability, or the like. The thickness of the second sound-absorbing member 20 may be, for example, 2 to 5 mm.

Examples of the fibers 11 in the first sound-absorbing member 10 and the fibers 31a in the base material layer 31 of the second sound-absorbing member 20 include resin fibers such as thermoplastic resin fibers, cellulosic fibers such as plant fibers, natural fibers such as animal fibers, inorganic fibers such as glass fibers, cotton shoddy such as recycled clothing fibers, and the like. Synthetic resin fibers can be used for the resin fibers, and examples of synthetic resins for the synthetic resin fibers include polyester resins such as polyethylene terephthalate (PET) resin, polyolefin resins such as polypropylene (PP) resin and polyethylene (PE) resin, polyamide (PA) resin, acrylic (PMMA) resin, and the like. The resin fibers may contain additives such as colorants. Examples of the binder 12 in the first sound-absorbing member 10 and the binder 31b in the base material layer 31 of the second sound-absorbing member 20 include thermoplastic binders, thermosetting binders, and the like. Examples of the thermoplastic binders include polyolefin resins such as PP resin and PE resin, polyester resins such as low-melting-point PET resin, and the like. The binders 12 and 31b may contain additives such as elastomers and colorants. The binders 12 and 31b may be fibrous binder fibers, and may also be included in fibers with conjugate structures such as core-sheath structures, side-by-side structures, or the like. The content ratio of the binders 12 and 31b in the fiber aggregates (the first sound-absorbing member 10 and the base material layer 31) may be, for example, 1 to 40 wt. %. Specific examples of the fiber aggregates include felt.

The floor interior member 40 more forward than the first sound-absorbing member 10 may a floor carpet with a backing resin layer integrated with the lower surface of the carpet layer, or the like. The floor interior member 40 is formed by press-molding a material containing fibrous material, and has a three-dimensional shape with unevenness. The floor interior member 40 has the rear edge part 41 placed on the front edge part 21 of the second sound-absorbing member 20, and is installed on the panel 110 at the position more forward than the first sound-absorbing member 10. The weight per unit area of the floor interior member 40 is not particularly limited, and may be, for example, 230 to 9500 g/m².

The front sound-insulating cover 51 has a lower edge 51b located on the upper surface 40a of the floor interior member 40, and the lower edge 51b is placed on the rear edge part 41. The front sound-insulating cover 51 keeps pressing the front edge part 21 of the second sound-absorbing member 20 from above through the floor interior member 40. This causes the front edge part 21 of the second sound-absorbing member 20 to be kept pressing from above by the weight of the front sound-insulating cover 51 and the floor interior member 40. As shown in FIG. 2, the shielding structure has the clearance CL1 between the front sound-insulating cover 51 and the second sound-absorbing member 20. Since the double wall with the clearance CL1 is formed of the front sound-insulating cover 51 and the second sound-absorbing member 20, it is possible to further reduce the noise and the heat from the battery unit 130.

The front sound-insulating cover 51 has the second opening 53 at the position corresponding to the first lid 23 shown in FIG. 5, and includes the lid 52 (an example of the second lid) capable of opening and closing the second opening 53. Herein, the portion of the front sound-insulating cover 51 excluding the lid 52 is referred to as a cover body 51e. The lid 52 can fit into the cover body 51e, and is detachably attached to the cover body 51e with a screw SC1.

The lower edge 56b of the rear sound-insulating cover 56 is placed on the rear edge part 22a of the second sound-absorbing member 20. The rear sound-insulating cover 56 directly keeps pressing the second edge part 22 of the second sound-absorbing member 20 from above, and keeps pressing the first sound-absorbing member 10 from above through the second sound-absorbing member 20. This causes the rear edge part 22a of the second sound-absorbing member 20 to be kept pressing from above by the weight of the rear sound-insulating cover 56, and the rear edge part 22a is kept pressing against the upper surface 10a of the first sound-absorbing member 10. The shielding structure has the clearance CL1 between the rear sound-insulating cover 56 and the second sound-absorbing member 20. Since the double wall with the clearance CL1 is formed of the sound-insulating cover 56 and the second sound-absorbing member 20, it is possible to further reduce the noise and the heat from the battery unit 130.

The sound-insulating cover 50 including the front sound-insulating cover 51 and the rear sound-insulating cover 56 may be a molded product of synthetic resin (including elastomer) such as thermoplastic resin, or the like.

Examples of the aforementioned thermoplastic resins include polyolefin resins such as PP resin and PE resin, polycarbonate (PC) resin, acrylonitrile butadiene styrene (ABS) resin, PA resin, and the like, and additives such as fibers may be included.

FIG. 7 schematically illustrates the main part of the shielding structure 1 with the second opening 53 of the front sound-insulating cover 51 in the open state. FIG. 8 schematically illustrates the main part of the shielding structure 1 with the first opening 24 of the second sound-absorbing member 20 in the open state.

In the state where the lid 52 is attached to the cover body 51e as shown in FIG. 1, the operator can remove the lid 52 from the cover body 51e, as shown in FIG. 7, by removing the screw SC1 from the cover body 51e. This causes the second opening 53 to be opened, and the first lid 23 of the second sound-absorbing member 20 appears. Next, the operator can open the first opening 24 of the second sound-absorbing member 20, as shown in FIG. 8, by peeling off the hook-and-loop fastener 28 from the first lid 23 and then pulling the first lid 23 forward through the second opening 53. The first lid 23 is in a folded state where the bending part 23c is positioned more forward than the upper edge 23a and the lower edge 23b. When the first opening 24 is opened, the connector 140 of the battery unit 130 appears.

From the above, the operator can access the connector 140 of the battery unit 130 through the second opening 53 of the front sound-insulating cover 51 via the first opening 24 of the second sound-absorbing member 20 by performing the operation of opening the lid 52 and then performing the operation of opening the first lid 23. For example, when the operator unplugs a plug from the connector 140, power supply to electrical equipment is turned off, and this makes it possible to perform maintenance of the battery unit 130, electrical equipment, and the like.

In the state where the first opening 24 is open as shown in FIG. 8, when the operator closes the first opening 24 with the first lid 23 and then secures the upper edge 23a of the first lid 23 with the hook-and-loop fastener 28, the first lid 23 is closing the first opening 24 as shown in FIG. 7. Next, when the operator fits the lid 52 into the cover body 51e at the position of the second opening 53 and fastens the screw SC1 to the cover body 51e, the lid 52 becomes closing the second opening 53 as shown in FIG. 1.

From the above, the operator can perform maintenance of the battery unit 130, electrical equipment, and the like without removing the sound-insulating cover 50 or the second sound-absorbing member 20.

It should be noted that the first sound-absorbing member 10, the second sound-absorbing member 20, and the floor interior member 40 can be formed, for example, by press-molding a sheet-like original material containing fibers and a binder into the required three-dimensional shape. The original material for forming the second sound-absorbing member 20 shown in FIG. 4 may be a laminated material in which a fibrous base material containing fibers 31a and a binder 31b, a binder sheet that will become the adhesive layer 32, and a design material that will become the fibrous design layer 33 are laminated in this order. The binder sheet may be omitted. When the binder is thermoplastic, the sound-absorbing members (10 and 20) and the floor interior member 40 can be obtained by heating the original material in a heating device to a temperature slightly higher than the melting point of the thermoplastic component contained in the original material, setting the heated original material in a press-molding machine, and press-molding the heated original material. Examples of the heating device include a suction heater (hot air circulation heater), an infrared heater, and the like. The press-molding may be hot pressing with heating or cold pressing without heating. When the press-molding machine is equipped with a heater, the original material set in the press-molding machine may be heated by the heater. When the temperature of the material drops below the melting point of the thermoplastic resin and the thermoplastic resin solidifies after the press-molding, the three-dimensional shapes of the sound-absorbing members (10 and 20) and the floor interior member 40 are maintained. The press-molded material may be cooled by a cooling mechanism. The press-molded material may be cut to a required shape by a cutting machine. Examples of the cutting machine include a cutting machine equipped with cutting blades, a cutting machine that performs cutting by water jet, and the like. In addition, cutting of the press-molded product can be performed by manual cutting using a cutter or the like, in addition to cutting by cutting blades or water jet cutting.

As described above, the sound-absorbing members (10 and 20) and the floor interior member 40 can be manufactured.

The front sound-insulating cover 51 and the rear sound-insulating cover 56 can be formed, for example, by injection molding of liquid resin such as molten resin. The injection-molded sound-insulating cover (51 or 56) can be obtained by injecting molten resin into an injection molding mold having a cavity whose shape corresponds to the three-dimensional shape of the sound-insulating cover (51 or 56), cooling the resin until it solidifies after injection molding, and opening the injection molding mold. The sound-insulating cover (51 or 56) may be injection-molded as a foam body by mixing a foaming agent into the molten resin and causing the molten resin to foam.

As described above, the sound-insulating covers (51 and 56) can be manufactured.

### (3) Specific Example of an Assembly Nethod for the Battery Unit Shielding Structure

The assembly of the shielding structure 1 can be performed, for example, in the following process order.
(A1) A first sound-absorbing member installation step of installing the first sound-absorbing member 10 on the upper surface 110a of the panel 110.
(A2) A battery unit installation step of placing the battery unit 130 on the upper surface 10a of the first sound-absorbing member 10.
(A3) A second sound-absorbing member installation step of covering the battery unit 130 with the second sound-absorbing member 20.
(A4) A floor interior member installation step of installing the floor interior member 40 on the upper surface 110a of the panel 110.
(A5) A sound-insulating cover installation step of covering the second sound-absorbing member 20 with the sound-insulating cover 50.

At least after the second sound-absorbing member installation step A3, an in-vehicle equipment installation step is performed for attaching the rear seat 120 located above the shielding structure 1 to the panel 110.

When the second sound-absorbing member installation step A3 is performed, the upper part 131 and the side parts 133 of the battery unit 130 is surrounded by the fibrous second sound-absorbing member 20, and the second edge part 22 (the rear edge part 22a, left edge part 22b, and right edge part 22c) of the second sound-absorbing member 20 is aligned with the upper surface 10a of the first sound-absorbing member 10.

When the floor interior member installation step A4 is performed, the rear edge part 41 of the floor interior member 40 is placed on the front edge part 21 of the second sound-absorbing member 20.

When the sound-insulating cover installation step A5 is performed, the lower edge 51b of the front sound-insulating cover 51 keeps pressing the front edge part 21 of the second sound-absorbing member 20 from above through the rear edge part 41 of the floor interior member 40, and the lower edge 56b of the rear sound-insulating cover 56 directly keeps pressing the rear edge part 22a of the second sound-absorbing member 20 from above.

The shielding structure 1 for the battery unit 130 can be easily assembled by the above uncomplicated operations. When the shielding structure 1 in which the battery unit 130 is surrounded by the first sound-absorbing member 10 and the second sound-absorbing member 20 is assembled, the noise and the heat from the battery unit 130 are effectively blocked by the shielding structure 1.

### (4) Operation and Effect of the Shielding Structure for the Battery Unit

The battery unit 130 draws air into its interior through the air intake ducts and expels warmed air from its interior through the exhaust ducts by driving the internal blower. Noise is generated from the blower inside the battery unit 130, and heat is generated from the battery unit 130. The noise emitted from the battery unit 130 in various directions is absorbed by the fibrous sound-absorbing members (10 and 20) surrounding the battery unit 130. The heat generated from the battery unit 130 is blocked by the fibrous sound-absorbing members (10 and 20) surrounding the battery unit 130.

The noise and the heat directed forward from the battery unit 130 are blocked by the floor interior member 40 placed on the front edge part 21 of the second sound-absorbing member 20, and by the double wall (the second sound-absorbing member 20 and the front sound-insulating cover 51) having the clearance CL1. The noise and the heat directed rearward from the battery unit 130 are blocked by the rear edge part 22a aligned with the upper surface 10a of the first sound-absorbing member 10, and by the double wall (the second sound-absorbing member 20 and the rear sound-insulating cover 56) having the clearance CL1. The noise and the heat directed leftward from the battery unit 130 are blocked by the left edge part 22b aligned with the upper surface 10a of the first sound-absorbing member 10. The noise and the heat directed rightward from the battery unit 130 are blocked by the right edge part 22c aligned with the upper surface 10a of the first sound-absorbing member 10.

From the above, the shielding structure 1 according to the present specific example effectively blocks the noise and the heat from the battery unit 130.

Therefore, the present specific example can provide the preferred shielding structure for reducing the noise and the heat from the battery unit in the vehicle.

### (5) Modified Examples

Various Modified Examples of the Present Invention Are Available.

For example, the front edge part 21 of the second sound-absorbing member 20 may be aligned with the upper surface 10a of the first sound-absorbing member 10.

A floor interior member different from the floor interior member 40 may be placed on the rear edge part 22a of the second sound-absorbing member 20.

It should be noted that even in cases where the second sound-absorbing member 20 does not have the first opening 24, where the sound-insulating cover 50 does not have the second opening 53, or where the shielding structure 1 does not have the sound-insulating cover 50, etc., the shielding structure 1 is still a preferred structure for reducing the noise from the battery unit 130 in the vehicle.

### (6) Conclusion

As explained above, according to the present invention, through various embodiments, configurations of the preferred shielding structure for reducing the noise from the battery unit in the vehicle and the like can be provided. Of course, configurations consisting of the components in each independent claim can produce the above-mentioned primary operation and effect.

It is also possible to implement configurations formed by exchanging or combining the components disclosed in the above-mentioned examples with each another, configurations formed by exchanging or combining components in related art and the components disclosed in the above-mentioned examples with each another, etc. The present invention implies these configurations and the like.

### REFERENCE SIGNS LIST

1 . . . shielding structure,
10 . . . first sound-absorbing member, 10a . . . upper surface, 11 . . . fiber, 12 . . . binder,
20 . . . second sound-absorbing member, 20a . . . outer surface, 20b . . . lower surface, 20e . . . body,
22 . . . second edge part, 22a . . . rear edge part, 22b . . . left edge part, 22c . . . right edge part,
23 . . . first lid, 24 . . . first opening, 25 . . . concave portion, 26 . . . recess, 28 . . . hook-and-loop fastener,
31 . . . base material layer, 31a . . . fiber, 31b . . . binder, 32 . . . adhesive layer, 33 . . . design layer,
50 . . . sound-insulating cover,
51 . . . front sound-insulating cover, 51b . . . lower edge, 52 . . . lid (example of second lid), 53 . . . second opening,
56 . . . rear sound-insulating cover, 56b . . . lower edge,
100 . . . automobile (example of vehicle),
110 . . . panel, 110a . . . upper surface,
120 . . . rear seat (example of in-vehicle equipment),
130 . . . battery unit, 131 . . . upper part, 132 . . . lower part, 133 . . . side part,
CL1 . . . clearance,
SP1 . . . interior space.

What is claimed is:

1. A shielding structure for a battery unit located above a panel and under in-vehicle equipment in a vehicle, the shielding structure comprising:
a fibrous first sound-absorbing member located on the panel and in contact with a lower part of the battery unit; and
a fibrous second sound-absorbing member surrounding an upper part and side parts of the battery unit, wherein
the battery unit is surrounded by the first sound-absorbing member and the second sound-absorbing member.

2. The shielding structure according to claim 1, further comprising:
a floor interior member located on the panel at a position more forward than the first sound-absorbing member, wherein
the second sound-absorbing member has a front edge part on which the floor interior member is placed, and a second edge part aligned with an upper surface of the first sound-absorbing member.

3. The shielding structure according to claim 1, further comprising
a sound-insulating cover outside the second sound-absorbing member surrounding the side parts of the battery unit, wherein the sound-insulating cover keeps pressing an edge part of the second sound-absorbing member from above, and
the shielding structure has a clearance between the sound-insulating cover and the second sound-absorbing member.

4. The shielding structure according to claim 3, wherein
the second sound-absorbing member has a first opening for accessing a connector of the battery unit, the second sound-absorbing member including a first lid capable of opening and closing the first opening, and
the sound-insulating cover has a second opening for accessing the connector through the first opening, the sound-insulating cover including a second lid capable of opening and closing the second opening.

5. The shielding structure according to claim 1, wherein
the second sound-absorbing member includes a fibrous base material layer and a fibrous design layer,
the fibrous base material layer whose weight per unit area is 300 to 1000 g/m² is in contact with the upper part of the battery unit, and
the fibrous design layer whose weight per unit area is 50 to 300 g/m² is adhered to the base material layer.
